(19) United States
(12) Patent Application Publication
(10) Pub. No.: US 2026/0093529 A1
(43) Pub. Date: Apr. 2, 2026

(54) Method for Processing Scheduled Task, Device, and Storage Medium

(71) Applicant: CLOUD INTELLIGENCE ASSETS HOLDING (SINGAPORE) PRIVATE LIMITED, Singapore (SG)

(72) Inventor: Chengming XU, Hangzhou, Zhejiang (CN)

(21) Appl. No.: 19/112,181

(22) PCT Filed: Oct. 9, 2023
(86) PCT No.: PCT/CN2023/123625

§ 371 Date: Mar. 14, 2025

(30) Foreign Application Priority Data
Oct. 13, 2022 (CN) 202211258241.7

(51) Int. Cl. G06F 9/48; G06F 9/50

(52) U.S. Cl. CPC G06F 9/4887; G06F 9/5022

(57) ABSTRACT

Embodiments of the present disclosure provide a method for processing a scheduled task, a device, and a storage medium. A proxy service is launched before a scheduled task framework launches, thereby disabling the scheduled task framework without user awareness using the proxy service; on this basis, a job controller in Kubernetes is called to create a container group for each scheduled task and use the container group to carry the scheduled task and the proxy service. Thus, the job controller manages the scheduled task instead of the scheduled task framework, the proxy service process the scheduled task and monitor an execution state of the scheduled task instead of the scheduled task framework, and after using the proxy service to detect that the execution of the target scheduled task has completed, the container group occupied by the target scheduled task is released.

The present disclosure claims priority of Chinese Patent Application No. 202211258241.7, filed to China National Intellectual Property Administration on Oct. 13, 2022 and titled “Method for Processing Scheduled Task, Device, and Storage Medium”, the content of which is hereby incorporated by reference in its entirety.

### TECHNICAL FIELD

The present disclosure relates to a cloud computing technology field, and particularly relates to a method for processing a scheduled task, a device, and a storage medium.

### BACKGROUND OF THE INVENTION

The processing of a scheduled task typically relies on a scheduled task framework. However, the scheduled task framework is a resident class model. In other words, the scheduled task framework continuously occupies computing resources regardless of whether the scheduled task is executed.

Currently, the industry has proposed serverless transformation solutions for the scheduled task framework to optimize the problem of resource occupation of the scheduled task. However, decomposition of task logic is required to be performed on the scheduled task framework and the task logic is required to be rewritten. Often, one single scheduled task framework contains dozens or even hundreds of task entities, making a decomposition process extremely complex. Such an invasive transformation of the scheduled task framework comes with high learning costs and complexity, leading to low user willingness to adopt these solutions for resolving the problem of resource occupation.

### SUMMARY OF THE INVENTION

Embodiments of the present disclosure provide a method for processing a scheduled task, a device, and a storage medium to improve the problem of resource occupation of the scheduled task.

Some embodiments of the present disclosure provide a method for processing a scheduled task, including that: in response to a target scheduled task meeting a launching condition, a job controller in Kubernetes is called to create a container group (pod) for the target scheduled task; before a scheduled task framework that the target scheduled task originally depends on launches, a proxy service in the container group (pod) is launched to disable the scheduled task framework; the target scheduled task in the container group (pod) is executed; after using the proxy service to detect that the execution of the target scheduled task has completed, the container group (pod) occupied by the target scheduled task is released.

Some embodiments of the present disclosure further provide a computing device, including a memory and a processor; the memory, arranged for storing at least one computer instruction; the processor, coupled with the memory and arranged for executing the at least one computer instruction to perform the following functions: in response to a target scheduled task meeting a launching condition, calling a job controller in Kubernetes to create a container group (pod) for the target scheduled task; before a scheduled task framework that the target scheduled task originally depends on launches, launching a proxy service in the container group (pod) to disable the scheduled task framework; executing the target scheduled task in the container group (pod); after using the proxy service to detect that the execution of the target scheduled task has completed, releasing the container group (pod) occupied by the target scheduled task.

Some embodiments of the present disclosure further provide a computer-readable storage medium storing computer instructions, where when executed by at least one processor, the computer instructions cause the at least one processor to perform the method for the processing scheduled task mentioned above.

### BRIEF DESCRIPTION OF DRAWINGS

In the drawings, unless otherwise specified, identical reference numerals throughout the various drawings indicate identical or similar parts or elements. The drawings are not necessarily to scale. It should be understood that these drawings depict some embodiments of the present disclosure and should not be construed as limiting the scope of the present disclosure.

The drawings described herein are provided to further understand the present disclosure, and form part of the present disclosure. The illustrative embodiments and description of the present disclosure are used for explaining the present disclosure and do not constitute improper limitations on the present disclosure. In the drawings:

FIG. 1 is a flow schematic diagram of a method for processing a scheduled task according to some exemplary embodiments of the present disclosure.

FIG. 2 is a logical schematic diagram of a method for processing a scheduled task according to some exemplary embodiments of the present disclosure.

FIG. 3 is a functional logic schematic diagram of a proxy service according to some exemplary embodiments of the present disclosure.

FIG. 4 is a structural schematic diagram of a computing device according to some exemplary embodiments of the present disclosure.

### DETAILED DESCRIPTION OF THE INVENTION

To make the purpose, technical solutions, and advantages of the present disclosure clearer, the following will describe the technical solutions of the present disclosure in detail in conjunction with specific embodiments of the present disclosure and corresponding drawings. Clearly, the described embodiments are a part of the embodiments of the present disclosure and not all of the embodiments. Based on the embodiments of the present disclosure, all other embodiments obtained by a person skilled in the art without making inventive efforts should fall within the protection scope of the present disclosure.

Currently, whether or not the scheduled task is executed, the scheduled task continuously occupies computing resources, leading to resource waste. To address this, in some embodiments of the present disclosure: a proxy service is launched before the scheduled task framework is launched, thereby disabling the scheduled task framework without user awareness through the proxy service. On this basis, the job controller in Kubernetes is called to create a container group (pod) for each scheduled task, and the container group (pod) is used for carrying the scheduled task and the proxy service. Thus, the job controller manages the scheduled task instead of the scheduled task framework, the proxy service processes the scheduled task and detects the execution state of the scheduled task, and after detecting that the execution of the scheduled task has been completed, the container group (pod) occupied by the scheduled task is released, thereby achieving stop automatically upon completion of the scheduled task. Consequently, serverless transformation of the scheduled task framework can be achieved without modifying the scheduled task framework, improving the problem of resource occupation of the scheduled task.

The following will describe in detail the technical solutions provided by embodiments of the present disclosure in conjunction with the drawings.

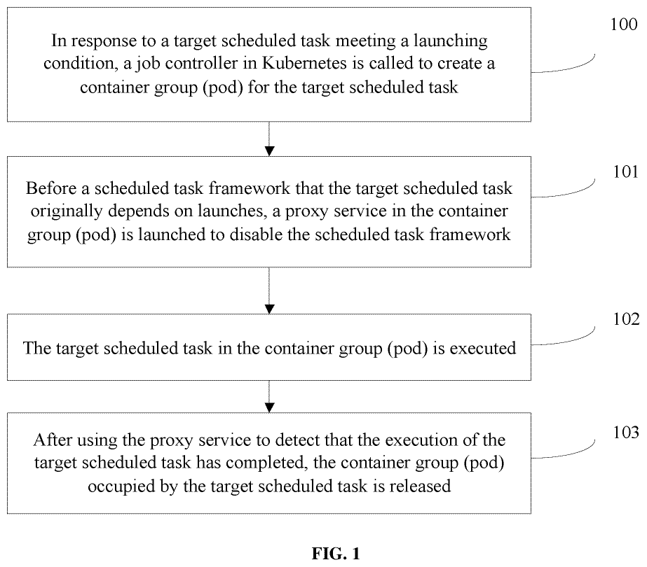

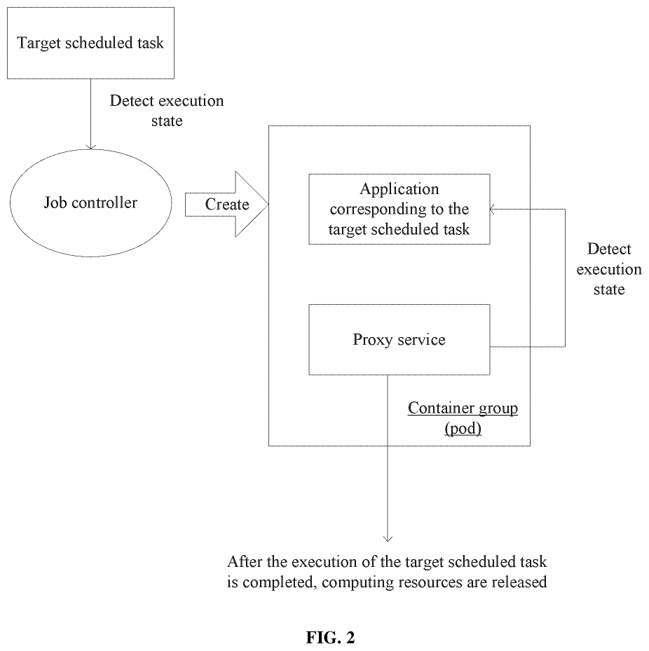

FIG. 1 is a flow schematic diagram of a method for processing a scheduled task according to some exemplary embodiments of the present disclosure. FIG. 2 is a logical schematic diagram of a method for processing a scheduled task according to some exemplary embodiments of the present disclosure. As shown in FIG. 1, the method includes the following steps.

In step 100, in response to a target scheduled task meeting a launching condition, a job controller in Kubernetes is called to create a container group (pod) for the target scheduled task.

In step 101, before a scheduled task framework that the target scheduled task originally depends on launches, a proxy service in the container group (pod) is launched to disable the scheduled task framework.

In step 102, the target scheduled task in the container group (pod) is executed.

In step 103, after using the proxy service to detect that the execution of the target scheduled task has completed, the container group (pod) occupied by the target scheduled task is released.

The solution for processing the scheduled task provided by some embodiments is applied to various scenarios where the scheduled task is required to rely on the scheduled task framework for processing. The application scenario is not limited by some embodiments. The scheduled task, as the name suggests, is a task required to be executed at fixed times. The scheduled task framework is a framework used for managing the scheduled task. The embodiments of the present disclosure do not limit the type of scheduled task framework, and the type of scheduled task framework includes but is not limited to Quartz, xxljob, elasticjob, spring task, etc.

The solution for processing the scheduled task provided by some embodiments can achieve the serverless transformation of the scheduled task framework. The serverless transformation in some embodiments mainly includes two aspects. In one aspect, the execution of the scheduled task no longer depends on local servers on a user side but is fully managed in a cloud side. In the other aspect, the scheduled task automatically stops upon completion and automatically releases resources.

For this purpose, some embodiments of the present disclosure propose calling the job controller in Kubernetes to schedule the scheduled task. Thus, the solution for processing the scheduled task provided by some embodiments of the present disclosure is based on Kubernetes as the underlying foundation. Kubernetes, abbreviated as k8s, is a container orchestration engine that supports automated deployment, large-scale scalability and application containerized management. In the Kubernetes, multiple container groups (pods) are created, each container group (pod) contain multiple containers, and an application instance runs in each container. In some embodiments, the container group (pod) is used for carrying the scheduled task.

Based on the underlying Kubernetes, as shown in FIG. 1 and FIG. 2, in step 100, in response to the launching condition of the target scheduled task being met, the job controller in the Kubernetes is called to create a container group (pod) for the target scheduled task.

Traditional scheduled task frameworks require additional dependency such as a scheduling center, or zookeeper, or db, etc., as a scheduler to achieve the scheduling of the scheduled task. In some embodiments, the job controller in the Kubernetes is called to schedule the scheduled task, eliminating the required for schedulers relied upon by the traditional scheduled task frameworks.

The job controller in the Kubernetes is used for managing jobs and the container groups (pods) created by the job controller. In some embodiments, the job controller supports features such as timeout, retry, blocking policies, and can be compatible with configurations of an original scheduled task framework. For this, in some embodiments, a configuration page for the job controller is provided to a user. In response to configuration operations on the configuration page, a configuration file for the job controller is generated. The job controller operates according to the configuration file. In the technical solution, the user is given the authority to configure the job controller, allowing the user to configure required task scheduling parameters as needed, including but not limited to retry count, retry interval, blocking policy, etc. Essentially, for the original scheduled task framework, the user is further required to configure the task scheduling parameters. However, in some embodiments, the user configures the task scheduling parameters into the configuration file of the job controller. Thus, through executing the configuration file for the job controller, the job controller schedules the scheduled task according to the task scheduling parameters configured by the user. The configuration file for the job controller is a yaml file. The user directly configures the yaml file. Or the user inputs the task scheduling parameters into a cloud product via a white-screened interface, and the cloud product generates the yaml file, with no limitation on the form of user configuration operations.

In some embodiments, the user no longer publishes the scheduled task according to a task format required by the traditional scheduled task frameworks but instead publishes the scheduled task according to task format requirements of the job controller. In other words, a publication format of the scheduled task issued by the user is compatible with the task format required by the job controller. For example, the task format supported by the job controller includes but is not limited to Cronjob, and certainly, these embodiments are not limited to this. CronJob, similar to crontab in a Linux system, arranged for managing time-based tasks and running specified tasks at specified intervals, which provides the basis for scheduling the scheduled task by calling the job controller in the Kubernetes.

At the time of publishing the scheduled task, the user further configures a timing strategy for the scheduled task. Therefore, in some embodiments, a creation interface for the scheduled task is provided to the user, and in response to the creation operations and timing strategy configuration operations in the creation interface, the scheduled task meeting the task format requirements of the job controller and the timing strategy associated with the scheduled task are generated. The timing strategy includes, but is not limited to, at least one of a launching condition, a time zone, number of shards, a restart condition, a timeout condition, a blocking condition, etc. The launching condition is used for specifying the timing for launching the scheduled task. The restart condition is used for specifying the requirements for restarting the scheduled task. The timeout condition is used for specifying the criteria for determining whether or not the scheduled task has timed out. On this basis, in step 100, the job controller obtains the timing strategy associated with the target scheduled task, which is pre-configured by the user for the target scheduled task, and the job controller detects whether or not the target scheduled task meets the launching condition based on the timing strategy. During this process, the job controller reads the launching condition from the timing strategy associated with the target scheduled task and combines the launching condition with actual current time information to determine whether or not the target scheduled task meets the launching condition. For example, for a Scheduled Task A, a launching condition of the Scheduled Task A is to run once daily at 10:00 AM, the job controller determines that the Scheduled Task A has met the launching condition when the actual time information is 10:00 AM, and the job controller creates a container group (pod) for the Scheduled Task A.

At this point, the container group (pod) carries an application corresponding to the target scheduled task.

Continuing to refer to FIG. 1 and FIG. 2, in step 101, the proxy service is launched in the container group (pod) before the original scheduled task framework that the target scheduled task depends on is launched, thereby disabling the scheduled task framework.

In step 101, the container group (pod) will carry both the application corresponding to the target scheduled task and the proxy service provided by some embodiments.

In some embodiments, byte code enhancement JAVA agent technology is used for launching the proxy service in the container group (pod) before the original scheduled task framework that the target scheduled task depends on is launched. In practice, a basic idea is to add the proxy service (such as Java Agent) when the container group (pod) launches. The proxy service is associated with a pre-configured JAR package, and a MANIFEST.MF file in the container group (pod) specifies a proxy class. The proxy class contains one premain method. Thus, when the proxy class is loaded in the container group (pod), the premain method of the proxy class is executed, and then the main method of the application corresponding to the scheduled task framework is executed. Through this mechanism, without modifying the original scheduled task framework, the proxy service can be automatically launched, and the original scheduled task framework will not be launched. This allows the proxy service to disable the scheduled task framework.

In some embodiments, the proxy service replaces the original scheduled task framework to process the scheduled task.

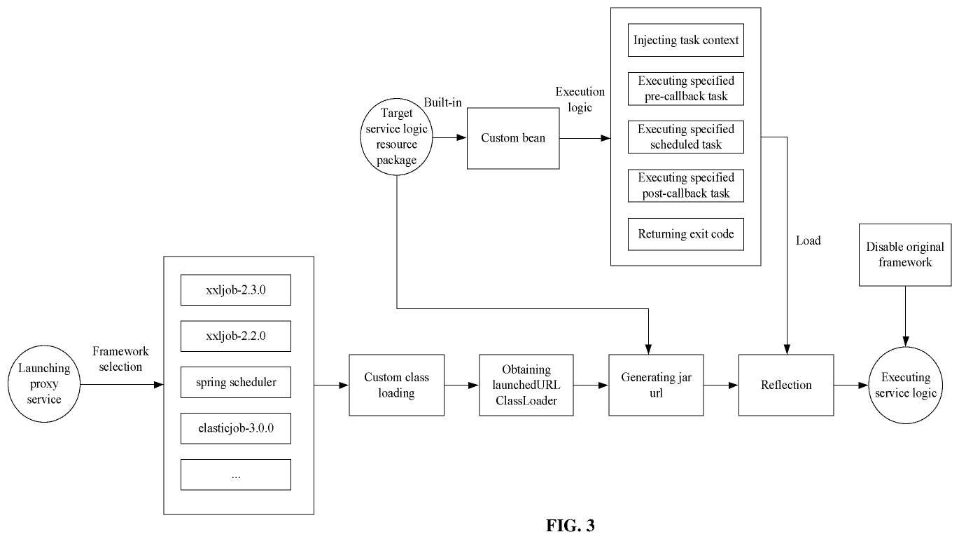

FIG. 3 is a functional logic schematic diagram of a proxy service according to some exemplary embodiments of the present disclosure. As shown in FIG. 3, in some embodiments, the proxy service specifies a target type of the scheduled task framework that the target scheduled task depends on from various types of the scheduled task frameworks, and obtains the service logic resource package associated with the target type. The service logic resource package serves as the target service logic resource package compatible with the scheduled task framework. On this basis, the proxy service performs a custom class loading operation in the container group (pod) to load the target service logic resource package compatible with the scheduled task framework. And then the proxy service processes the target scheduled task according to the service logic in the target service logic resource package. As mentioned above, some embodiments of the present disclosure designate a proxy class for the proxy service, thereby breaking a traditional parent-first delegation model in Java. Therefore, in some embodiments, during a class loading process, a custom class loader is obtained to search for and load the target service logic resource package from a predefined path using the custom class loader. The service logic resource package is in a jar format or other formats.

To support the proxy service in executing the service logic in the target service logic resource package, in some embodiments, the proxy service discovers at least one of the target scheduled task, a pre-callback task corresponding to the target scheduled task, and a post-callback task corresponding to the target scheduled task in the container group (pod). It is known to inventors that in the traditional scheduled task frameworks, a specific class or method is typically marked via an interface or annotation to indicate “the scheduled task to be executed” and “a callback task before executing the scheduled task and a callback task after executing the scheduled task”. Therefore, in some embodiments, the proxy service uses a reflection mechanism to discover at least one of the target scheduled task, the pre-callback task corresponding to the target scheduled task, and the post-callback task corresponding to the target scheduled task. For example, the proxy service uses a reflection mechanism to find the specific class or method marked with the interface or annotation in the target class, thus discovering at least one of the target scheduled task, the pre-callback task corresponding to the target scheduled task, and the post-callback task corresponding to the target scheduled task.

The target service logic resource package is generated by encapsulating a task processing logic from the scheduled task framework that the target scheduled task depends on. In some embodiments, different types of scheduled task frameworks are encapsulated separately to obtain different service logic resource packages compatible with different scheduled task frameworks. Thus, the service logic in the target service logic resource package includes but is not limited to executing the pre-callback task corresponding to the target scheduled task, executing the target scheduled task, and executing the post-callback task corresponding to the target scheduled task. Based on this, the proxy service can execute these service logics to process the target scheduled task.

When executing the service logic “execute the target scheduled task” in the target service logic resource package, in some embodiments, the target scheduled task is triggered to run in the container group (pod). To ensure the smooth execution of the target scheduled task in the container group (pod), the service logic in the target service logic resource package further includes injecting task description information into a task context of the target scheduled task. To achieve this injection, in some embodiments, the job controller injects environment variables into the container group (pod), where the environment variables identify the task description information of the target scheduled task. The proxy service recognizes the environment variables to obtain the task description information of the target scheduled task. The proxy service injects the task description information into the task context of the target scheduled task, allowing the task logic of the target scheduled task is executed based on the task description information. In practice, the user configures the job controller to inject the environment variables into the container group (pod) by specifying relevant logic in the configuration file of the job controller. Thus, when creating the container group (pod), the job controller injects the environment variables into the container group (pod). The proxy service recognizes the environment variables to obtain the task description information of the scheduled task. The task description information includes but is not limited to a task ID, a task name, task execution parameters, total number of task shards, current shard number, and current shard parameters. Through injecting the task description information into the task context of the target scheduled task, the task logic of the target scheduled task is executed in the container group (pod).

As shown in FIG. 1 and FIG. 2, in step 103, the proxy service detects after the execution of the target scheduled task has completed and then the container group (pod) occupied by the target scheduled task is released.

In some embodiments, the service logic in the target service logic resource package further includes outputting an exit code. Based on this, in some embodiments, the proxy service generates the exit code representing a completion state of the target scheduled task based on the execution result of the target scheduled task. For example, when the target scheduled task completes successfully, a value of the exit code is 0. Conversely, when the target scheduled task fails, the value of the exit code value is 1. Thus, in step 103, in response to the exit code indicating that the target scheduled task has completed, the container group (pod) occupied by the target scheduled task is released, thereby achieving stop automatically upon completion of the scheduled task and timely releasing the container group (pod) occupied by the target scheduled task.

The following describes a processing solution for the scheduled task provided by some embodiments with an illustrative application scenario.

In this illustrative application scenario, the Scheduled Task A originally depends on a Scheduled Task Framework a to run, and a type of the Scheduled Task Framework a is Quartz. The Scheduled Task Framework a includes a JobDetail, a Trigger, and a Scheduler. Originally, the Scheduled Task Framework a runs on a local server of the user or a cloud server rented by the user, and the user publishes the Scheduled Task A in deployment format. Based on the processing solution for the scheduled task provided by some embodiments, the user publishes the Scheduled Task A in a cronjob format, associates a scheduling policy with the Scheduled Task A, and specifies the launching condition, the time zone and other parameters for the Scheduled Task A. The user further configures task scheduling parameters in the yaml file corresponding to the job controller, or the provider of the processing solution constructs and configures the yaml file. On this basis, the job controller in the Kubernetes is called to schedule cronjobs published by the user and manage the lifecycle of each of the cronjobs.

The job controller executes the yaml file to work according to the preset logic and task scheduling parameters of the yaml file. As a result, the job controller detects that the scheduled task is required to launch based on the scheduling policy associated with the Scheduled Task A and creates a pod for the scheduled task.

After creating the pod, the proxy service (namely agent) provided by some embodiments is added to the pod, and the environment variables are injected into the pod. Thus, the pod carries both the application corresponding to the Scheduled Task A and the agent.

Through adding the agent to the pod, the pod no longer launches the Scheduled Task Framework a but instead loads a specified jar package via the proxy service and runs the pre-configured service logic within the jar package. During this process:

The agent performs framework selection to choose the type corresponding to the Scheduled Task Framework a.

The agent performs a custom class loading operation to obtain a custom class loader lanchedurlclassloader and generate the jar url for the jar package associated with the selected framework type, thereby acquiring the required jar package. The jar package encapsulates the original task processing logic from the Quartz and the jar package is stored in a designated path for calling.

The agent discovers the Scheduled Task A, a callback task before executing the Scheduled Task A and a callback task after executing the Scheduled Task A through the reflection mechanism on the pod, obtains the task description information for the Scheduled Task A through recognizing the environment variables and the task description information is injected into the task context of the Scheduled Task A.

Thus, the agent triggers the execution of the callback task before executing the Scheduled Task A, the execution of the Scheduled Task A, and the execution of the callback task after executing the Scheduled Task A.

The Scheduled Task A on the pod executes the task logic based on the task context injected into the task description information.

The agent further detects the execution state of the Scheduled Task A and output an exit code 1 upon successful execution.

In response to the exit code being 1, the computing resources occupied by the Scheduled Task A are promptly released to achieve pay-as-you-go billing for the Scheduled Task A.

Accordingly, the processing solution for the scheduled task provided by some embodiments leverages the Java Agent technology to support zero-modification Java scheduled task framework applications in constructing task contexts, running specified tasks, and achieving stop automatically upon completion. The job controller in the Kubernetes is used to replace the task scheduling and core feature-related functionalities of the original Java scheduled task framework and manage the lifecycle of the tasks. Through combining these two points, zero-modification support for the serverless transformation of the Java scheduled task framework can be achieved, enabling compatibility with relevant scheduled task features (such as timeouts, retries, blocking, etc.) while ensuring stop automatically upon completion of the tasks, thereby allowing the user to pay for the execution of the scheduled task, greatly saving on user resources and manpower costs. Moreover, the user focuses on the specific task logic of the scheduled task without managing or operating functions related with the task scheduling.

It should be noted that in the processes described in the above embodiments and illustrated in the figures, multiple operations are presented in a particular order, but it should be clearly understood that these operations can be executed out of the order they appear or in parallel, and the operation numbers like 101, 102, etc., are used for distinguishing different operations, and the numbers do not represent any execution order. Additionally, these processes can include more or fewer operations, which can be executed sequentially or in parallel.

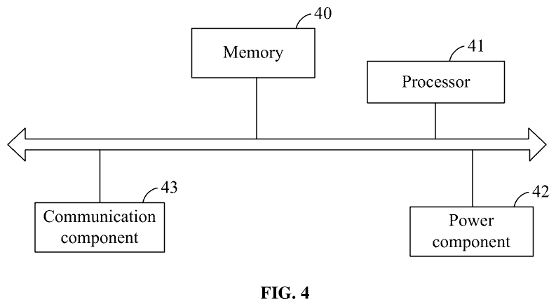

FIG. 4 is a structural block diagram of a computing device according to some exemplary embodiments of the present disclosure. As shown in FIG. 4, the computing device includes: a memory 40 and a processor 41.

The processor 41 is coupled with the memory 40 and arranged for executing the computer program stored in the memory 40 to perform the following functions:
in response to a target scheduled task meeting a launching condition, calling a job controller in Kubernetes to create a container group (pod) for the target scheduled task;
before a scheduled task framework that the target scheduled task originally depends on launches, launching a proxy service in the container group (pod) to disable the scheduled task framework;
executing the target scheduled task in the container group (pod);
after using the proxy service to detect that the execution of the target scheduled task has completed, releasing the container group (pod) occupied by the target scheduled task.

The computing device provided by some embodiments can be a cloud server or a virtual machine running on a cloud server, and some embodiments does not limit this.

In some embodiments, the processor 41 is further arranged for:
using the job controller to inject environment variables into the container group (pod), where the environment variables are used for identifying task description information of the target scheduled task;
using the proxy service to recognize the environment variables to obtain the task description information of the target scheduled task;
using the proxy service to inject the task description information into a task context of the target scheduled task, so that the target scheduled task executes task logic of the target scheduled task based on the task description information.

In some embodiments, the processor 41 is further arranged for:
performing a custom class loading operations in the container group (pod) through the proxy service to load a target service logic resource package compatible with the scheduled task framework;
using the proxy service to process the target scheduled task according to service logic in the target service logic resource package.

In some embodiments, the target service logic resource package is generated by pre-packaging task processing logic from the scheduled task framework.

In some embodiments, during a process of using the proxy service to process the target scheduled task according to the service logic in the target service logic resource package, the processor 41 is further arranged for:
using the proxy service to discover at least one of the target scheduled task, a pre-callback task corresponding to the target scheduled task and a post-callback task corresponding to the target scheduled task in the container group (pod);
triggering the execution of at least one of the target scheduled task, the pre-callback task corresponding to the target scheduled task and the post-callback task corresponding to the target scheduled task;
using the proxy service to generate an exit code representing a completion state of the target scheduled task based on an execution result of the target scheduled task.

In some embodiments, during a process of after using the proxy service to detect that the execution of the target scheduled task has completed, releasing the container group (pod) occupied by the target scheduled task, the processor 41 is further arranged for:
in response to the exit code indicating that the execution of the target scheduled task has completed, releasing the container group (pod) occupied by the target scheduled task.

In some embodiments, the processor 41 is further arranged for:
providing a configuration page for the job controller to a user;
generating a configuration file corresponding to the job controller in response to a configuration operation performed on the configuration page;
where the job controller operates according to the configuration file.

In some embodiments, the processor 41 is further arranged for:
using the job controller to obtain a scheduling policy associated with the target scheduled task, the scheduling policy being pre-configured by a user for the target scheduled task;
using the job controller to detect whether the target scheduled task meets the launching condition based on the scheduling policy.

In some embodiments, the scheduling policy may include at least one of the following: the launching condition, a time zone, number of shards, a restart condition, a timeout condition and a blocking condition.

In some embodiments, a publication format of the target scheduled task conforms to task format requirements of the job controller.

As shown in FIG. 4, in some embodiments, the computing device further includes components such as a communication component 42, a power component 43, etc. FIG. 4 schematically shows some of the components and does not imply that the computing device only includes the components shown in FIG. 4.

It needs to be noted that the technical details regarding the various embodiments of the computing device mentioned above can refer to the relevant descriptions in the aforementioned method embodiments, and are not repeated here to save space. However, this should not lead to a loss of the scope of protection of the present disclosure.

Correspondingly, some embodiments of the present disclosure further provide a computer-readable storage medium storing a computer program, where when executed by a computing device, the computer program causes the computing device to perform the steps of aforementioned method embodiments.

The memory depicted in FIG. 4 arranged for storing the computer program and further storing various types of data to support the operations on a computing platform. Examples of the data include instructions for any applications or methods operating on the computing platform, contact data, phonebook data, messages, images, videos, etc. The memory is implemented by any type of transitory or non-transitory storage device or a combination thereof, such as Static Random-Access Memory (SRAM), Electrically Erasable Programmable Read-Only Memory (EEPROM), Erasable Programmable Read-Only Memory (EPROM), Programmable Read-Only Memory (PROM), Read-Only Memory (ROM), magnetic storage, flash memory, magnetic disks, or optical discs.

The communication component shown in FIG. 4 is arranged for facilitating wired or wireless communication between a device on which the communication component is arranged and other devices. The device arranged with the communication component connects to wireless networks based on communication standards, such as WiFi, mobile communication networks including 2G, 3G, 4G or LTE, 5G, or their combinations. In some embodiments, the communication component receives broadcast signals or broadcast-related information from an external broadcast management system via a broadcast channel. In some embodiments, the communication component further includes a Near Field Communication (NFC) module to facilitate short-range communications. For example, the NFC module is implemented based on Radio Frequency Identification (RFID) technology, Infrared Data Association (IrDA) technology, Ultra-Wideband (UWB) technology, Bluetooth (BT) technology, and other technologies.

The power component shown in FIG. 4 provides power to the various components of the device on which the power component is arranged. The power component includes a power management system, at least one power source, and other components associated with generating, managing, and distributing power for the device on which the power component is arranged.

In the embodiments of the present disclosure, the proxy service is launched before the scheduled task framework is launched, thereby disabling the scheduled task framework without user awareness through the proxy service. On this basis, the job controller in Kubernetes is called to create the container group (pod) for each scheduled task, and the container group (pod) is used for carrying the scheduled task and the proxy service. Thus, the job controller manages the scheduled task instead of the scheduled task framework, the proxy service processes the scheduled task and detects the execution state of the scheduled task, and after detecting that the execution of the scheduled task has been completed, the container group (pod) occupied by the scheduled task is released, thereby achieving stop automatically upon completion of the scheduled task. Consequently, serverless transformation of the scheduled task framework can be achieved without modifying the scheduled task framework, improving the problem of resource occupation of the scheduled task.

A person skilled in the art should understand that the embodiments of the present disclosure can be provided as a method, a system, or a computer program product. Accordingly, the present disclosure can take the form of entirely hardware embodiments, entirely software embodiments, or embodiments combining software and hardware aspects. Moreover, the present disclosure can take the form of the computer program product embodied on at least one computer-usable storage medium (including but not limited to disk storage, CD-ROM, optical storage, etc.) having computer-usable program code embodied therein.

The present disclosure is described with reference to flowcharts and/or block diagrams of methods, devices (systems), and computer program products according to embodiments of the present disclosure. It will be understood that each block of the flowchart illustrations and/or block diagrams, and combinations of blocks in the flowchart illustrations and/or block diagrams, can be implemented by computer program instructions. These computer program instructions can be provided to a processor of a general-purpose computer, special-purpose computer, embedded processor, or other programmable data processing device to produce a machine, such that the instructions, which are executed by the processor of the computer or other programmable data processing device, create an apparatus for implementing the functions specified in at least one flow of the flowchart and/or at least one block of the block diagram.

These computer program instructions are further stored in a computer-readable memory that directs a computer or other programmable data processing device to function in a particular manner, such that the instructions stored in the computer-readable memory produce an article of manufacture including instruction apparatus which implement the function specified in at least one flow of the flowchart and/or at least one block of the block diagram.

These computer program instructions are further loaded into a computer or other programmable data processing device to cause a series of operational steps to be performed on the computer or other programmable device to produce a computer-implemented process such that the instructions, which are executed on the computer or other programmable device, provide steps for implementing the functions specified in at least one flow of the flowchart and/or at least one block of the block diagram.

In a typical configuration, the computing device includes at least one processor (such as CPU), input/output interfaces, network interfaces and memory.

The memory includes non-persistent storage in a computer-readable medium, random access memory (RAM), and/or non-transitory memory forms, such as read-only memory (ROM) or flash RAM. The memory is an example of a computer-readable medium.

The computer-readable medium includes both permanent and non-permanent, removable and non-removable medium implemented in any method or technology for storing information. The information can be computer-readable instructions, data structures, modules of a program, or other data. Examples of the computer storage medium include, but are not limited to, Programmable Read-Only Memory (PRAM), Static Random-Access Memory (SRAM), Dynamic Random-Access Memory (DRAM), other types of Random-Access Memory (RAM), Read-Only Memory (ROM), Electrically Erasable Programmable Read-Only Memory (EEPROM), flash memory or other memory technologies, Compact Disc Read-Only Memory (CD-ROM), Digital Versatile Discs (DVDs), or other optical storage, magnetic cassettes, magnetic tape, magnetic disk storage, or other magnetic storage devices, or any other non-transmission medium that can be used for storing information accessible by the computing device. As defined herein, the computer-readable medium does not include transitory media, such as modulated data signals and carriers.

It needs to be further noted that the terms “includes”, “including”, or any other variation thereof are intended to cover a non-exclusive inclusion, such that a process, method, commodity, or device that includes a list of elements does not include only those elements but further include other elements not expressly listed or inherent to such process, method, commodity, or device. An element preceded by “a” or “an” does not, without more constraints, preclude the existence of additional identical elements in the process, method, commodity, or device that includes the element.

The above description is illustrative of the embodiments of the present disclosure and is not intended to limit the present disclosure. Various modifications and changes can be made to the present disclosure by a person skilled in the art. Any modification, equivalent replacement, improvement, etc., made within the spirit and principle of the present disclosure should be included within the scope of protection of the present disclosure.

1. A method for processing a scheduled task, comprising:
in response to a target scheduled task meeting a launching condition, calling a job controller in Kubernetes to create a container group (pod) for the target scheduled task;
before a scheduled task framework that the target scheduled task originally depends on launches, launching a proxy service in the container group (pod) to disable the scheduled task framework;
executing the target scheduled task in the container group (pod);
after using the proxy service to detect that the execution of the target scheduled task has completed, releasing the container group (pod) occupied by the target scheduled task.

2. The method according to claim 1, further comprising:
using the job controller to inject environment variables into the container group (pod), wherein the environment variables are used for identifying task description information of the target scheduled task;
using the proxy service to recognize the environment variables to obtain the task description information of the target scheduled task;
using the proxy service to inject the task description information into a task context of the target scheduled task, so that the target scheduled task executes task logic of the target scheduled task based on the task description information.

3. The method according to claim 1, further comprising:
performing a custom class loading operations in the container group (pod) through the proxy service to load a target service logic resource package compatible with the scheduled task framework;
using the proxy service to process the target scheduled task according to service logic in the target service logic resource package.

4. The method according to claim 3, wherein the target service logic resource package is generated by pre-packaging task processing logic from the scheduled task framework.

5. The method according to claim 3, wherein using the proxy service to process the target scheduled task according to the service logic in the target service logic resource package comprises:
using the proxy service to discover at least one of the target scheduled task, a pre-callback task corresponding to the target scheduled task and a post-callback task corresponding to the target scheduled task in the container group (pod);
triggering the execution of at least one of the target scheduled task, the pre-callback task corresponding to the target scheduled task and the post-callback task corresponding to the target scheduled task;
using the proxy service to generate an exit code representing a completion state of the target scheduled task based on an execution result of the target scheduled task.

6. The method according to claim 5, wherein after using the proxy service to detect that the execution of the target scheduled task has completed, releasing the container group (pod) occupied by the target scheduled task comprises:
in response to the exit code indicating that the execution of the target scheduled task has completed, releasing the container group (pod) occupied by the target scheduled task.

7. The method according to claim 1, further comprising:
providing a configuration page for the job controller to a user;
generating a configuration file corresponding to the job controller in response to a configuration operation performed on the configuration page;
wherein the job controller operates according to the configuration file.

8. The method according to claim 1, further comprising:
using the job controller to obtain a scheduling policy associated with the target scheduled task, the scheduling policy being pre-configured by a user for the target scheduled task;
using the job controller to detect whether the target scheduled task meets the launching condition based on the scheduling policy.

9. The method according to claim 8, wherein the scheduling policy comprises at least one of the following: the launching condition, a time zone, number of shards, a restart condition, a timeout condition and a blocking condition.

10. The method according to claim 1, wherein a publication format of the target scheduled task conforms to task format requirements of the job controller.

11. A computing device, comprising a memory and a processor;
the memory, arranged for storing at least one computer instruction;
the processor, coupled with the memory and arranged for executing the at least one computer instruction to perform the following functions:
in response to a target scheduled task meeting a launching condition, calling a job controller in Kubernetes to create a container group (pod) for the target scheduled task;
before a scheduled task framework that the target scheduled task originally depends on launches, launching a proxy service in the container group (pod) to disable the scheduled task framework;
executing the target scheduled task in the container group (pod);
after using the proxy service to detect that the execution of the target scheduled task has completed, releasing the container group (pod) occupied by the target scheduled task.

12. A computer-readable storage medium storing computer instructions, wherein when executed by at least one processor, the computer instructions cause the at least one processor to perform the following functions:
in response to a target scheduled task meeting a launching condition, calling a job controller in Kubernetes to create a container group (pod) for the target scheduled task;
before a scheduled task framework that the target scheduled task originally depends on launches, launching a proxy service in the container group (pod) to disable the scheduled task framework;
executing the target scheduled task in the container group (pod);
after using the proxy service to detect that the execution of the target scheduled task has completed, releasing the container group (pod) occupied by the target scheduled task.

13. The method according to claim 1, the container group (pod) carries an application corresponding to the target scheduled task.

14. The method according to claim 1, before the scheduled task framework that the target scheduled task originally depends on launches, launching the proxy service in the container group (pod) to disable the scheduled task framework comprising:
before the scheduled task framework that the target scheduled task originally depends on launches, launching, through byte code enhancement JAVA agent technology, the proxy service in the container group (pod) to disable the scheduled task framework.

15. The method according to claim 14, further comprising:
adding the proxy service when the container group (pod) launches, wherein the proxy service is associated with a pre-configured JAR package, a MANIFEST.MF file in the container group (pod) specifies a proxy class, and the proxy class contains a premain method.

16. The method according to claim 15, further comprising:
when the proxy class is loaded in the container group (pod), executing the premain method of the proxy class, and then executing a main method of an application corresponding to the scheduled task framework.

17. The method according to claim 3, further comprising:
using the proxy service to specify a target type of the scheduled task framework that the target scheduled task depends on from various types of the scheduled task frameworks, and obtain the service logic resource package associated with the target type, so that the service logic resource package serves as the target service logic resource package compatible with the scheduled task framework.

18. The method according to claim 3, wherein during a class loading process, a custom class loader is obtained to search for and load the target service logic resource package from a predefined path using the custom class loader.

19. The method according to claim 5, wherein using the proxy service to discover at least one of the target scheduled task, the pre-callback task corresponding to the target scheduled task and the post-callback task corresponding to the target scheduled task in the container group (pod) comprises:
using the proxy service to use a reflection mechanism to discover at least one of the target scheduled task, the pre-callback task corresponding to the target scheduled task and the post-callback task corresponding to the target scheduled task in the container group (pod).

20. The method according to claim 5, wherein when the target scheduled task completes successfully, a value of the exit code is 0, and when the target scheduled task fails, the value of the exit code value is 1.
